(19) United States
(12) Patent Application Publication
(10) Pub. No.: US 2023/0184223 A1
(43) Pub. Date: Jun. 15, 2023

(54) METHOD FOR PREDICTIVE MONITORING OF THE CONDITION OF WIND TURBINES

(71) Applicant: FLUENCE ENERGY, LLC, Arlington, VA (US)

(72) Inventors: Gianmarco PIZZA, Zurich (CH); Eskil JARLSKOG, Zurich (CH)

(73) Assignee: FLUENCE ENERGY, LLC, Arlington, VA (US)

(21) Appl. No.: 17/997,561

(22) PCT Filed: Jun. 30, 2020
(86) PCT No.: PCT/IB2020/056187

§ 371 Date: Oct. 31, 2022

(51) Int. Cl. F03D 17/00

(52) U.S. Cl. CPC F03D 17/00; F05B 2270/303; F05B 2270/404

(57) ABSTRACT

A method for predictive monitoring of the condition of wind turbines is disclosed. The method may include selecting at least one wind turbine inside a wind farm and at least one component of the wind turbine; acquiring SCADA data comprising operational data of the wind farm and temperature values of the at least one component of the wind turbine during a preselected time period, calculating differential data as a difference between the temperature values of the selected turbine component of the selected wind turbine and an average temperature of the selected wind turbine component in at least two wind turbines in the wind farm; defining a monitoring time period to monitor the component; calculating at least one predetermined statistic of the differential data during the monitoring time period, and saving the predetermined statistic as a monitoring feature; and testing if at least one monitoring feature exceeds a threshold value.

### TECHNICAL FIELD

The present invention relates to a method for predictive monitoring of the condition of power generating plants, and in particular, it relates to the condition monitoring of wind turbines.

### BACKGROUND

Power plants of different types have in common the requirements for the maintenance of various critical parts such as turbines, pumps, gearboxes, generators, etc. The requirements for such kind of services and maintenance are demanding with the need for high reliability with low downtime. Traditionally, the preventive type of maintenance is applied where the service and control are performed periodically regardless of the state of the power generating device or the specific component. This approach has the advantage of simplicity and ease of implementation. However, there are various disadvantages related to the preventive maintenance approach such as the unnecessary servicing of certain parts and the inability of the prediction of the need for servicing other parts more frequently. These disadvantages could drive the total cost of the maintenance, and in some cases, they can lead to failures of the components and costly downtime.

In recent decades, wind power has become increasingly popular as a way of power generation, and it is already replacing a significant part of the traditional power plants such as coal plants and gas plants. At the same time, the maintenance of wind turbines is becoming a critical issue.

It is an aim of the present invention to mitigate at least some of the disadvantages of the condition monitoring and maintenance currently applied for power generation plants and in particular wind farms.

### SUMMARY

According to the present invention, there is provided a method for predictive monitoring of the condition of wind turbines, the method comprising the steps of:
selecting at least one wind turbine inside a wind farm and at least one component of the wind turbine;
acquiring supervisory control and data acquisition (SCADA) data comprising operational data of the wind farm during a preselected time period, wherein the SCADA data comprises temperature values of the at least one component of the wind turbine during the preselected time period;
processing SCADA data comprising calculating differential data, wherein the differential data is a difference between the temperature values of the selected turbine component of the selected wind turbine and an average temperature of the selected wind turbine component in at least two wind turbines in the wind farm;
defining a monitoring time period to monitor the component, wherein the monitoring time interval is shorter than the preselected time period;
extracting features, wherein the extraction of the features comprises calculating at least one predetermined statistic of the differential data during the monitoring time period, and saving the predetermined statistics as a monitoring feature; and
testing if at least one monitoring feature exceeds a threshold value.
   The method is characterized in that the step of the extracting the features further comprises calculating at least one predetermined statistic of the differential data during a reference time period, and that the reference time period is at least partially overlapping the monitoring time period and saving the predetermined statistic as a reference feature.
   The threshold value is a function of at least one reference feature.

In an embodiment the method comprises the step of sending an alarm in the case that at least one monitoring feature exceeds the corresponding threshold value.

In an embodiment of the method the predetermined statistics comprise one or the combination of linear interpolation, average, and standard deviation of the differential data.

In an embodiment of the method the testing step further comprises calculating the total number of the differential data points during the monitoring time period and/or the reference time period.

In an embodiment the method comprises the step of filtering SCADA data to eliminate low-power data, wherein the low-power data is determined based on a preselected power threshold.

In an embodiment of the method the step of processing SCADA data further comprises averaging of the SCADA data over a predefined period of time. Preferably, the averaging is performed over the period ranging from one hour to one year.

In an embodiment of the method the average temperature of the wind turbine component is calculated over all the wind turbines in the entire wind farm that are of the same model.

In an embodiment of the method the wind turbine component is one of main bearing, generator, hydraulic oil system, inverter, transformer and gearbox.

In an embodiment of the method the preselected time period over which the SCADA data is collected is longer than one year.

In an embodiment of the method the monitoring feature is one-day average or one-month average of the differential data.

In an embodiment of the method the monitoring feature is one-week average or one-month average of the differential data, and/or the reference feature is one-week or one-month average of the differential data.

In an embodiment of the method the monitoring feature and/or the reference feature is the slope of the linear interpolation of the differential data.

In an embodiment of the method the slope is calculated over at least one of the time periods with a duration of half a month, one month, three months, six months and nine months.

In another aspect of the invention, there is provided a computer-readable storage medium comprising instructions, which when executed by a computer cause the computer to carry out the steps of the method of any of embodiments described above.

### BRIEF DESCRIPTION OF THE DRAWINGS

The invention will be better understood with the aid of the description of embodiments given by way of example only and illustrated by the figures, in which:

FIG. 1 shows a flow diagram of the method for condition monitoring in accordance with one embodiment of the invention;

FIG. 2 shows a flow diagram of the selection step in accordance with one embodiment of the invention;

FIG. 3 shows a flow diagram of the processing step in accordance with one embodiment of the invention;

FIG. 4 shows a flow diagram of the filtering of data in the processing step in accordance with one embodiment of the invention;

FIG. 5 shows a flow diagram of the example of feature extraction in accordance with one embodiment of the invention;

FIG. 6A and FIG. 6B show a schematic illustration of various time periods.

### DETAILED DESCRIPTION

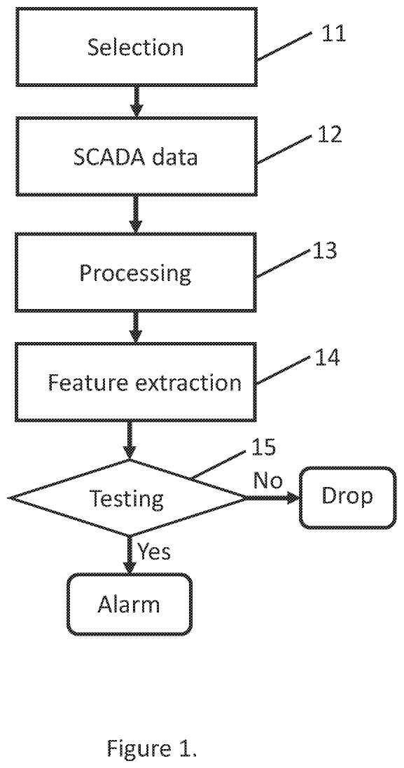

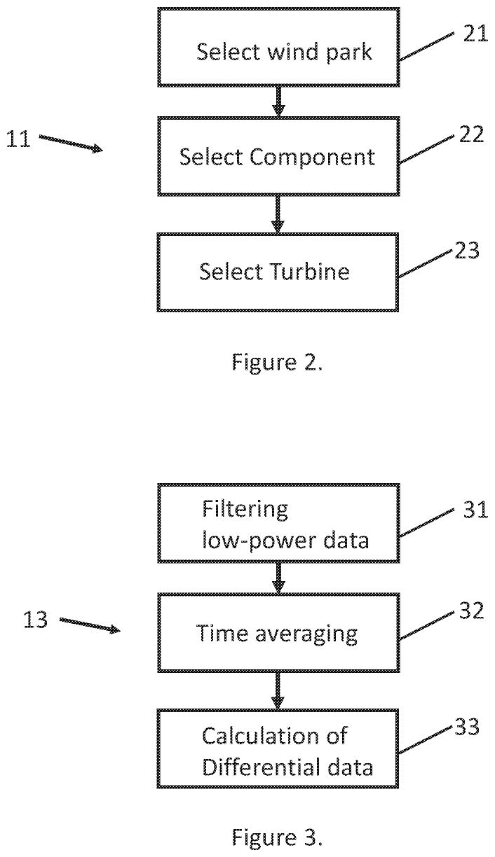

FIG. 1 shows a flow diagram of the method for condition monitoring in accordance with one embodiment of the invention. The first step in the method may be a selection step 11 as shown in more detail in FIG. 2. In the first step 21 of the selection process, a specific wind farm is selected. In the next step 22, at least one component of the wind turbines in the wind farm is selected. In the preferred embodiment, this component may be, but not limited to: main bearing, generator, hydraulic oil system and gearbox of the wind turbine. In the final step 23 of the selection process 11, at least one wind turbine to be monitored is selected. The method allows also to monitor multiple turbines and components of the wind turbines in parallel.

As shown in FIG. 1, step 12 of the method comprises acquiring supervisory control and data acquisition (SCADA) data of the wind farm, or of the one part of the wind farm comprising a minimum of two wind turbines. In one preferred embodiment, the SCADA data across whole farm is collected. The SCADA data contains operation data of the wind turbine or wind farm. In general, the SCADA system is a control system of a plant or turbine used for high-level process supervisory management. The SCADA system performs a supervisory operation over a variety of the devices and components of the controlled system. In general, SCADA data contains vast information collected by the sensors inside the wind turbine. In the preferred embodiment, the SCADA data comprises temperature values of the at least one component of the wind turbine during a preselected time period. In one embodiment, the SCADA data comprises the temperature values of all the critical components of the wind turbine. The SCADA data is collected in time periods which may range from few minutes to few years. The time intervals between the measurement points in SCADA data varies depending on the required accuracy, for example, the intervals could range from a few seconds or multiple minutes. For every measurement point and the specific component of the wind turbine, SCADA data may record the series of information as a tuple (T, t, P, Temp), where T is name of the turbine, t is the time of the measurement, P is power of the turbine at time t, and Temp is the temperature of the selected component at time t. SCADA data is normally available to the users, so advantageously the method may not need any additional measurements or installation of new devices.

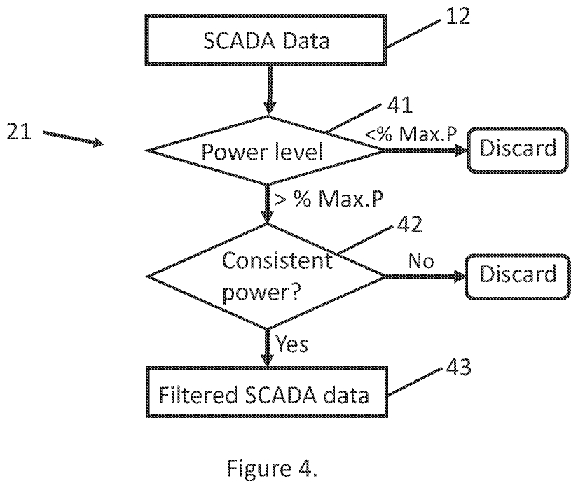

After acquiring the SCADA data, the data is processed in step 13 of the method. In one preferred embodiment shown in FIG. 3, the SCADA data may go through the three steps of: filtering low-power data 31, time averaging of the data 32, and calculation of differential data 33. The first two steps, 31 and 32, may serve to improve the quality and to make processing faster. In one embodiment, step 13 is consisting only of step 33. The step of filtering out low power data is shown in more detail in flow chart in FIG. 4. For each data point in the SCADA data power level is tested in step 41. In the case that the power level is lower than the certain percentage of maximum power the data point is discarded. The certain percentage of the maximum power may be for example in the range of 0 to 90%. The data points with the power value higher than the certain percentage of maximum power are further tested in step 42. Step 42 checks if the turbine has been consistently producing power (producing more than a certain threshold) during a certain, so-called, consistency time period prior to the time of the measurement of the that particular data point. If this is not the case the data point is discarded. Otherwise the data is saved as filtered SCADA data in step 43.

In one embodiment, step 32, time-averaging, which may have the following steps, is performed: defining duration and resolution of time intervals; calculation and storage of the time intervals; for each time interval the average of all data points in the interval is calculated and saved. In one embodiment, the SCADA data points originally recorded every 10 minutes are averaged to daily resolution. In general, the resolution parameters that may be used are time unit (hour or day), the number of time units (positive integer) and moving average (positive integer). The process of averaging may be repeated for every turbine of the wind farm that is monitored.

Step 33, which is the calculation of the differential data, may comprise the calculation of the difference between temperature of the selected wind turbine component of the selected wind turbine and an average temperature of the selected wind turbine component in at least two wind turbines in the wind farm. In one preferred embodiment, the average temperature of the wind turbine component is calculated over all the wind turbines in the wind farm that are of the same model. In one embodiment, for each pre-processed or raw SCADA data point dᵢ=(tᵢ, Tᵢ) the differential data point δᵢ=Tᵢ−T̅ᵢ is calculated, where tᵢ—denotes the time corresponding to the i:th data point; Tᵢ—denotes the component temperature corresponding to the i:th data point; T̅ᵢ—denotes the average farm component temperature of the turbines which have the same model as the one that is described by the data point. The process of calculating the differential data may be repeated for every turbine in the wind farm that is analyzed.

Step 14, shown in FIG. 1, shows the feature extraction step. In one embodiment, the extraction of the features comprises calculating at least one predetermined statistic of the differential data during a monitoring time period and saving the predetermined statistics as a monitoring feature. The monitoring time period may be selected in the selection step 11, or it may be selected at a later stage, but before the step of the feature extraction. In one embodiment the monitoring time period is one day or one month. In one embodiment the step of the feature extraction further comprises calculating at least one predetermined statistic of the differential data during a reference time period, wherein the reference time period is at least partially overlapping the monitoring time period and saving the predetermined statistic as a reference feature. The predetermined statistic may comprise one or the combination of: linear interpolation, average and standard deviation of the differential data.

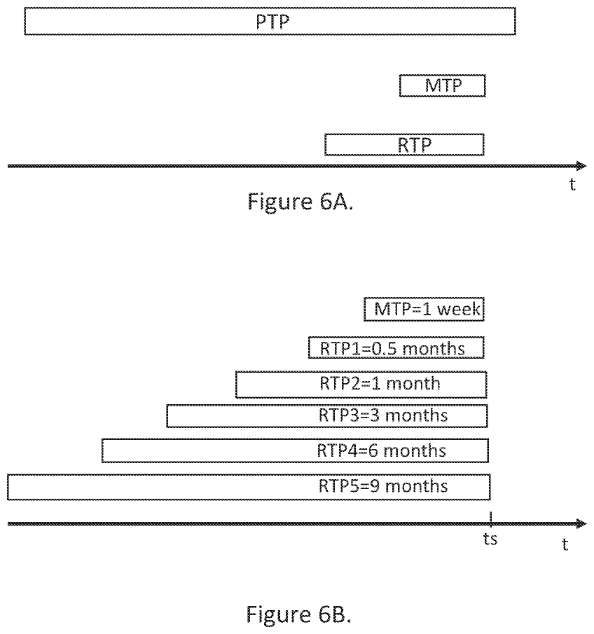

Various time periods as a function of time are visualized in FIG. 6A. The predetermined time period (PTP) is usually a long period lasting months or years. The monitoring time period (MTP) is usually short period lasting, for example, days or months. Finally, the reference time period (RTP) is at least partially overlapping the monitoring time period, and it can be, for example, days or months. The examples of the durations are provided for illustration purposes, and they are not limiting.

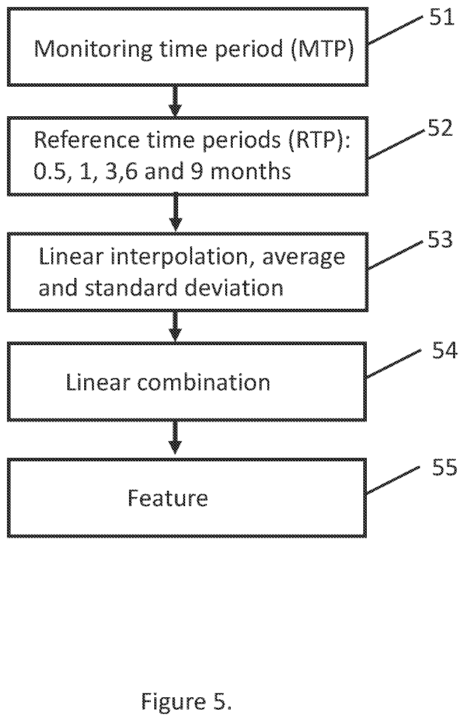

The example of the embodiment of the feature extraction is shown in the flow diagram in FIG. 5. In step 51, the monitoring time period MTP is selected, which may be for example one week as shown in FIG. 6A. From pre-processed SCADA data, five reference time periods (RTP1, RTP2, RTP3, RTP4, and RTP5) are selected in step 52. The selected reference time periods have durations of 0.5, 1, 3, 6 and 9 months as shown in FIG. 6B. The monitoring time period and the reference time periods end at the same time is as shown in FIG. 6B. Linear interpolation, average and standard deviation are calculated and saved for each reference time period in step 53. In step 54, the linear combinations of the statistics is calculated and saved as the reference features in final step 55. Using the monitoring time period similar monitoring features may be calculated.

In one non-limiting example, the features may be categorized in the three categories:
Short term increase features: for example, one-day average and one-month average;
Slope features: for example, slopes of the interpolated lines of the periods with a duration of 0.5, 1, 3, 6 and 9 months;
Consistent long-term increase features: for example, one-month average, three-month average, six-month average and nine-month average.
   In another embodiment, the feature may be the linear combination of at least two of the short term increase feature, the slope feature and the consistent long-term increase feature.

After the feature extraction is performed, there is the testing step 15 as shown in FIG. 1. This step is testing if the at least one monitoring feature exceeds a corresponding threshold value. In the preferred embodiment, the threshold value is a function of the at least one reference feature.

In one preferred embodiment all the thresholds are based on the standard deviation of the pre-processed time series containing the temperature of the component which has been monitored. For example, an alarm is triggered if the following condition is satisfied:

mean_day>mean_month+x*std_month

where mean_day is a monitoring feature corresponding to statistic of average value of the component temperature during the monitoring time of one day; mean_month is reference feature corresponding to the statistic of mean value temperature during the period of one month before the monitoring time; std_month is reference feature corresponding to the statistic of standard deviation of the temperature during the one month before the monitoring time; and x is an adjustable parameter, which is dependent on the component.

In one embodiment, the test may be performed as follows:
If any of the short term increase features exceeds its threshold, then send an alert;
If any of the slope features exceeds its threshold, then send an alert;
If all of the consistent long term increase features exceed their thresholds, then send an alert.

Further examples are provided in the following paragraphs using definitions:

mean(T, ts, n) denotes the mean of the pre-processed time series, before the alerting stage, starting at the timestamp corresponding to n days before ts (exclusive) and ending at ts (inclusive). For example, mean(T, 2019-01-10, 7) is the mean of the time series over the days 2019-01-04, 2019-01-05, . . . , 2019-01-10 which is 7 days in total;
slope(T, ts, n) denotes the slope of the linear interpolation of the pre-processed time series, before the alerting stage, starting at the timestamp corresponding to n days before ts (exclusive) and ending at ts (inclusive); For instance slope(T, 2019-01-10, 7) is the slope of the linear interpolation of the time series over the days 2019-01-04, 2019-01-05, . . . , 2019-01-10 which is 7 days in total. If the time series would have the same values for all of these days then the slope would be equal to 0;
std(T, ts, n) denotes the standard deviation of the pre-processed time series for all turbines of the same model as Tin the wind farm, before the alerting stage, starting at the timestamp corresponding to x days before ts (exclusive) and ending at ts (inclusive);
count(T, ts, n) denotes the total number of data points that is in of the pre-processed time series, before the alerting stage, starting at the timestamp corresponding to x days before ts (exclusive) and ending at ts (inclusive). There might for various reasons be no data point in the time series for a date, this because all points might have been filtered out in the power filtering stage so that there are no data points left for the entire day.

Below is a list of condition of alerts. If any of these conditions are satisfied then the alarm is sent.

mean(T,ts,7)>mean(T,ts,30)+x_week*std(T,ts,10) and count(T,ts,7)>1, where x_week=0.9. Short term condition 1:

mean(T,ts,1)>mean(T,ts,30)+x_day*std(T,ts,10), where x_day=1.9. Short term condition 2:

slope(T,ts,14)>x_2 week*std(T,ts,10) and count(T,ts,14)>3, where x_2 week=0.07. Slope condition 2 weeks:

slope(T,ts,30)>x_month*std(T,ts,10) and count(T,ts,30)>8, where x_2month=0.05. Slope condition 1 month:

slope(T,ts,90)>x_3month*std(T,ts,10) and count(T,ts,90)>count(T,ts,30)+10 and slope(T,ts,30)>0, where x_3month=0.026. Slope condition 3 months:

slope(T,ts,180)>x_6month*std(T,ts,10) and count(T,ts,180)>count(T,ts,90)+20 and slope(T,ts,30)>0 and slope(T,ts,90)>0, where x_6month=0.013. Slope condition 6 months:

slope(T,ts,270)>x_9month*std(T,ts,10) and count(T,ts,270)>count(T,ts,180) and slope(T,ts,30)>0 and slope(T,ts,90)>0 and slope(T,ts,180)>0, where x_9month=0.004. Slope condition 9 months:

mean(T,ts,1)>mean (T,ts,30) and mean (T,ts,30)−mean (T,ts,90)>y_month*std(T,ts,10) and mean (T,ts,90)−mean (T,ts,180)>y_3month*std(T,ts,10), where y_month=0.21 and y_3month=0.15. Long term condition:

The method according to the invention offers several advantages compared to the traditional methods for the power generation assets.

Using the method according to the invention it is possible to identify the failure patterns and to release alarms at an early stage, which allows for the more efficient risk management of the critical components' failures and increase of the energy output by minimizing costly downtimes.

1. A method for predictive monitoring of the condition of wind turbines, the method comprising the steps of:
selecting at least one wind turbine inside a wind farm and at least one component of the wind turbine;
acquiring SCADA data comprising operational data of the wind farm during a preselected time period, wherein the SCADA data comprises temperature values of the at least one component of the wind turbine during the preselected time period;
processing SCADA data comprising calculating differential data, wherein the differential data is a difference between the temperature values of the selected wind turbine component of the selected wind turbine and an average temperature of the selected wind turbine component in at least two wind turbines in the wind farm;
defining a monitoring time period to monitor the component, wherein the monitoring time interval is shorter than the preselected time period; and
extracting features, wherein the extraction of the features comprises:
calculating at least one predetermined statistic of the differential data during the monitoring time period, and saving the predetermined statistic as a monitoring feature; and
testing if at least one monitoring feature exceeds a threshold value, characterized in that the step of the extracting the features further comprises
calculating at least one predetermined statistic of the differential data during a reference time period, wherein the reference time period is at least partially overlapping the monitoring time period, and saving the predetermined statistic as a reference feature,
wherein the threshold value is a function of the at least one reference feature.

2. The method of claim 1, further comprising the step of sending an alarm in the case that at least one monitoring feature exceeds its corresponding threshold value.

3. The method of claim 1, wherein the predetermined statistics comprise one or the combination of: linear interpolation, average, and standard deviation of the differential data.

4. The method of claim 1, wherein the testing step further comprises calculating the total number of the differential data points during the monitoring time period and/or the reference time period.

5. The method of claim 1, further comprising the step of filtering SCADA data to eliminate low-power data, wherein the low-power data is determined based on a preselected power threshold.

6. The method of claim 1, wherein the step of processing SCADA data further comprising averaging of the SCADA data over a predefined time period.

7. The method of claim 6, wherein the averaging is performed over the period ranging from one hour to one year.

8. The method of claim 1, wherein the average temperature of the wind turbine component is calculated over all the wind turbines in the wind farm that are of the same model.

9. The method of claim 1, wherein the wind turbine component is one of main bearing, generator, hydraulic oil system, inverter, transformer and gearbox.

10. The method of claim 1, wherein the preselected time period is longer than one year.

11. The method of claim 1, wherein the monitoring feature is one-day average or one-month average of the differential data.

12. The method of claim 1, wherein the monitoring feature is one-week average or one-month average of the differential data, and/or wherein the reference feature is one-week or one-month average of the differential data.

13. The method of claim 1, wherein the monitoring feature and/or the reference feature is the slope of the linear interpolation of the differential data.

14. The method of claim 13, wherein the slope is calculated over at least one of the time periods with a duration of half-month, one month, three months, six months and nine months.

15. A non-transitory computer-readable storage medium comprising instructions, which when executed by a computer, cause the computer to carry out the steps of:
selecting at least one wind turbine inside a wind farm and at least one component of the wind turbine;
acquiring SCADA data comprising operational data of the wind farm during a preselected time period, wherein the SCADA data comprises temperature values of the at least one component of the wind turbine during the preselected time period;
processing SCADA data comprising calculating differential data, wherein the differential data is a difference between the temperature values of the selected wind turbine component of the selected wind turbine and an average temperature of the selected wind turbine component in at least two wind turbines in the wind farm;
defining a monitoring time period to monitor the component, wherein the monitoring time interval is shorter than the preselected time period; and
extracting features, wherein the extraction of the features comprises:
calculating at least one predetermined statistic of the differential data during the monitoring time period, and saving the predetermined statistic as a monitoring feature; and
testing if at least one monitoring feature exceeds a threshold value, characterized in that the step of the extracting the features further comprises
calculating at least one predetermined statistic of the differential data during a reference time period, wherein the reference time period is at least partially overlapping the monitoring time period, and saving the predetermined statistic as a reference feature,
wherein the threshold value is a function of the at least one reference feature.
